(19) United States
(12) Patent Application Publication
(10) Pub. No.: US 2026/0032115 A1
(43) Pub. Date: Jan. 29, 2026

(54) INTELLIGENT DNS LOAD BALANCING USING COMBINATION OF DYNAMIC DNAT POOL AND APPLICATION PROBING IN CONNECTOR BASED SOLUTION FOR PRIVATE APPLICATION ACCESS

(71) Applicant: Palo Alto Networks, Inc., Santa Clara, CA (US)

(72) Inventors: Brian Russell Kean, Cincinnati, OH (US); Ketan Kulkarni, San Jose, CA (US); Jayant Jain, Cupertino, CA (US); Mingfei Peng, Pleasanton, CA (US)

(21) Appl. No.: 18/786,056

(22) Filed: Jul. 26, 2024

(51) Int. Cl. H04L 9/40; H04L 43/106; H04L 47/125; H04L 61/4511

(52) U.S. Cl. CPC H04L 63/0876; H04L 43/106; H04L 47/125; H04L 61/4511; H04L 63/20

(57) ABSTRACT

The present application discloses a method, system, and computer system for providing intelligent DNS load balancing using a combination of a dynamic DNAT pool and application providing in a connector-based solution for private application access. The method includes: (a) performing a DNS re-resolution for resolving an application Fully Qualified Domain Name (FQDN) to obtain a plurality of IP addresses for a plurality of application servers, (b) performing periodic application server probing, and (c) dynamically updating a destination network address translation (DNAT) to provide DNS load balancing for application traffic. The DNAT is updated based at least in part on one or more of the DNS re-resolution and the application server probing.

### BACKGROUND OF THE INVENTION

In today's highly interconnected world, the efficiency and reliability of internet services are critical for businesses and users alike. Domain Name System (DNS) plays a fundamental role in this infrastructure by translating human-readable domain names into IP addresses, enabling browsers and other applications to locate and access websites and services. As the internet continues to grow, the need for robust DNS solutions becomes increasingly important.

Traditional DNS load balancing involves distributing incoming DNS queries across multiple servers to ensure optimal resource utilization, improve response times, and enhance fault tolerance. Basic DNS load balancing techniques, such as round-robin, failover, and geographic distribution, have been widely used to manage traffic and maintain service availability. However, these conventional methods often fall short when dealing with dynamic complex traffic patterns, and complex network architectures, leading to inefficiencies and potential downtime.

### BRIEF DESCRIPTION OF THE DRA WINGS

Various embodiments of the invention are disclosed in the following detailed description and the accompanying drawings.

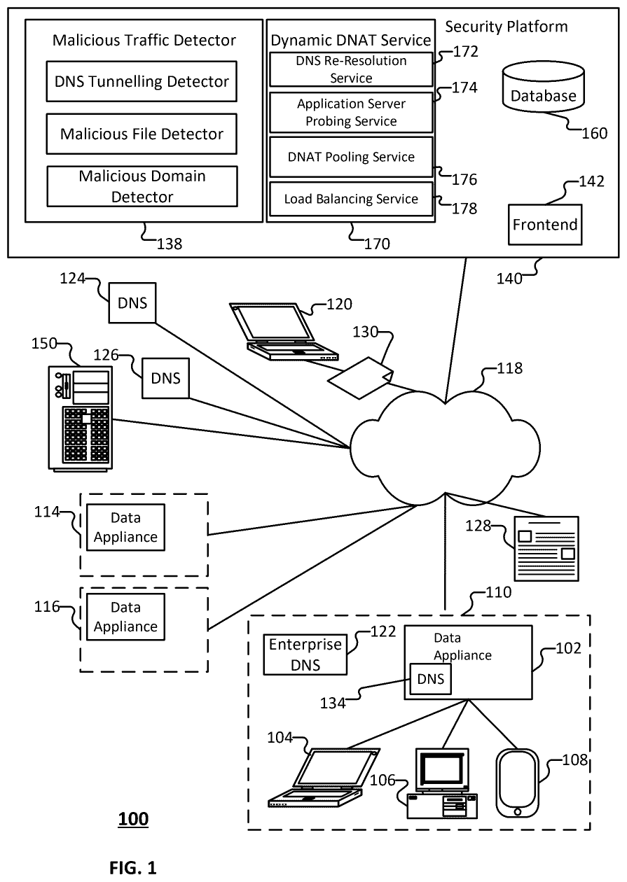

FIG. 1 is a block diagram of an environment for load balancing application traffic across one or more application servers according to various embodiments.

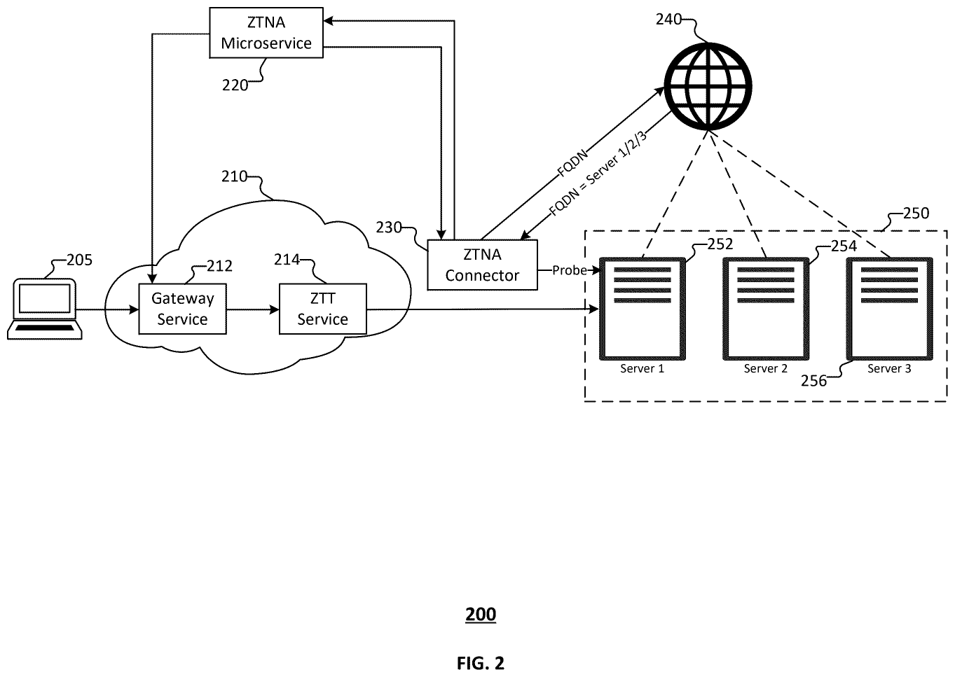

FIG. 2 is a block diagram of an environment for load balancing application traffic across one or more application servers according to various embodiments.

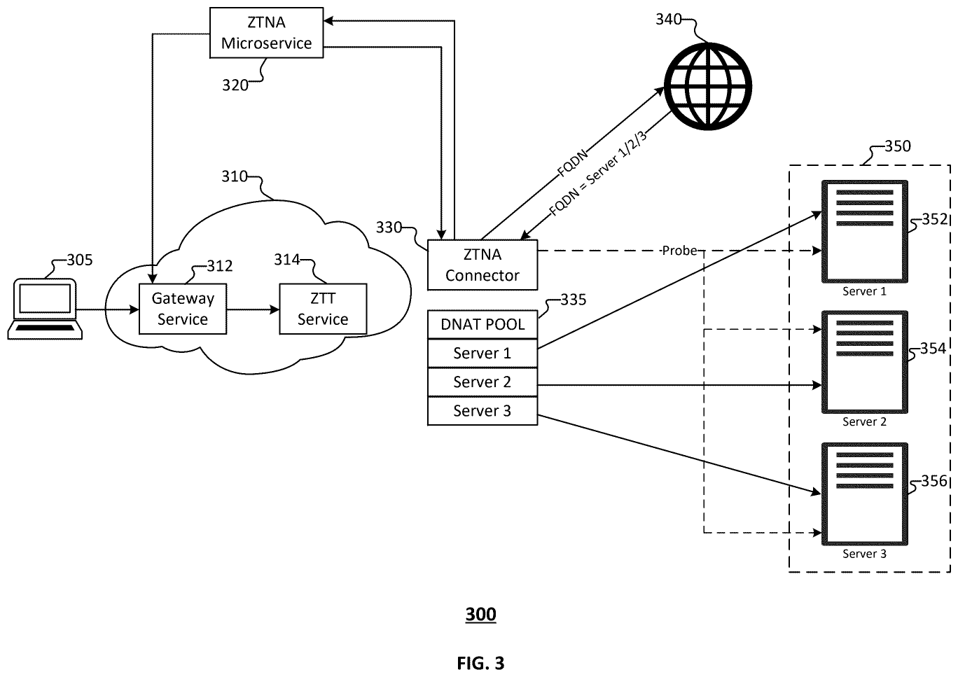

FIG. 3 is a block diagram of an environment for load balancing application traffic across one or more application servers according to various embodiments.

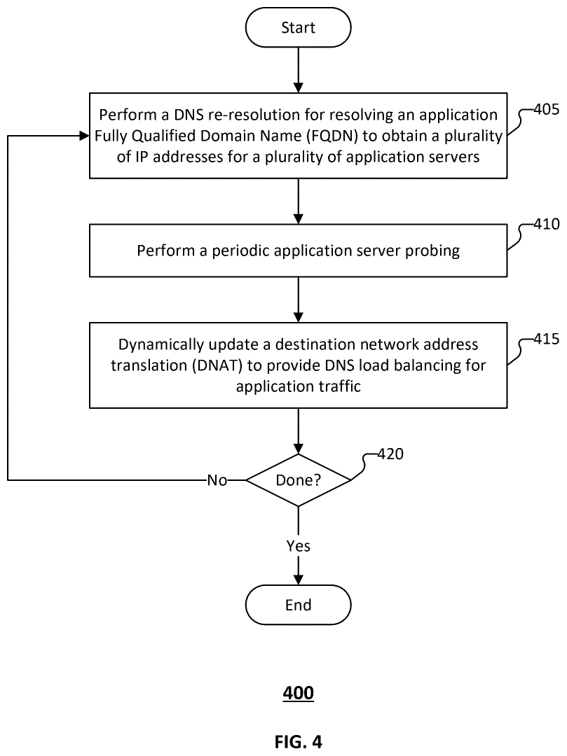

FIG. 4 is a flow diagram of a method for dynamically updating a destination network address translation (DNAT) according to various embodiments.

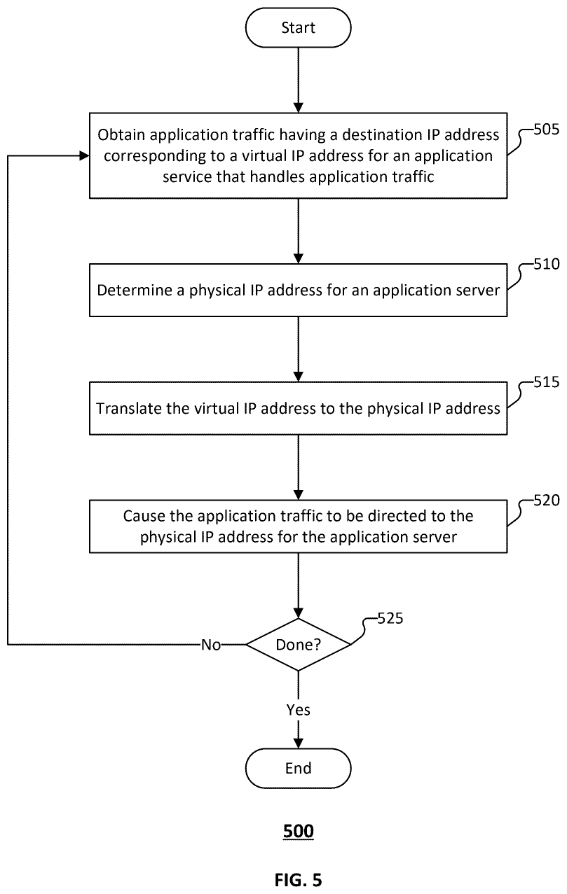

FIG. 5 is a flow diagram of a method for directing application traffic to an application server according to various embodiments.

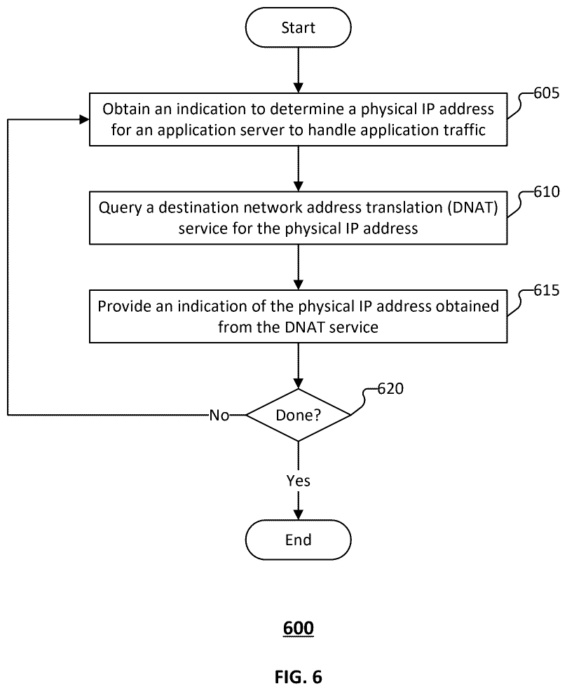

FIG. 6 is a flow diagram of a method for determining an application server that is to handle application traffic according to various embodiments.

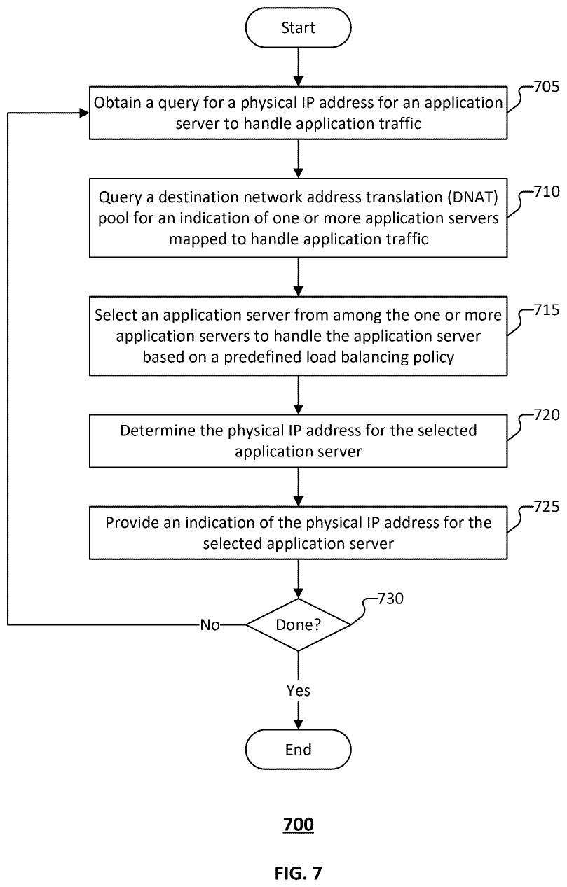

FIG. 7 is a flow diagram of a method for selecting an application server in a dynamic destination network address translation (DNAT) pool to handle application traffic according to various embodiments.

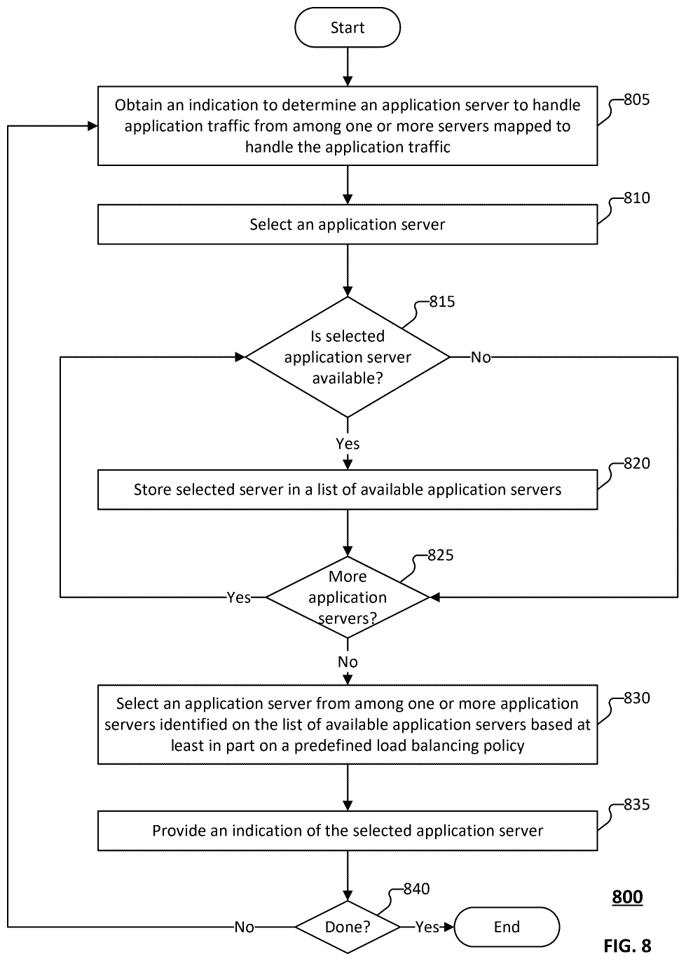

FIG. 8 is a flow diagram of a method for selecting an application server in a dynamic destination network address translation (DNAT) pool to handle application traffic according to various embodiments.

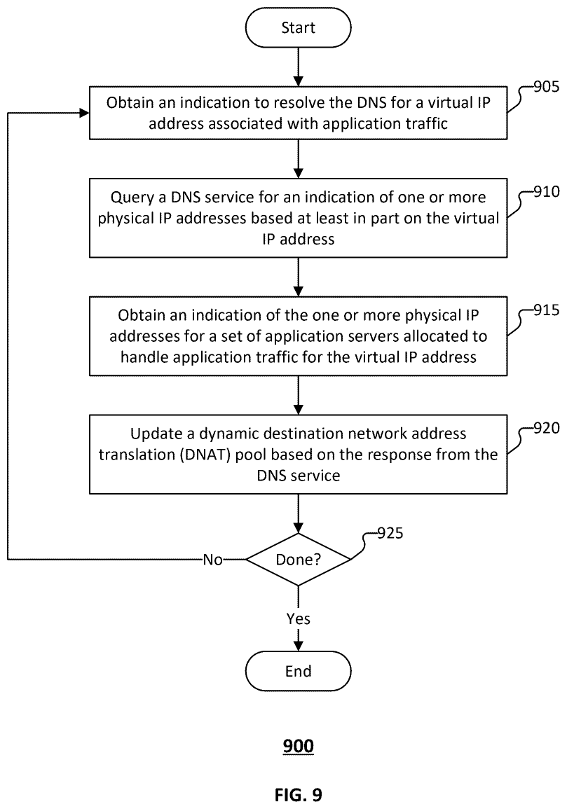

FIG. 9 is a flow diagram of a method for updating a dynamic destination network address translation (DNAT) pool according to various embodiments.

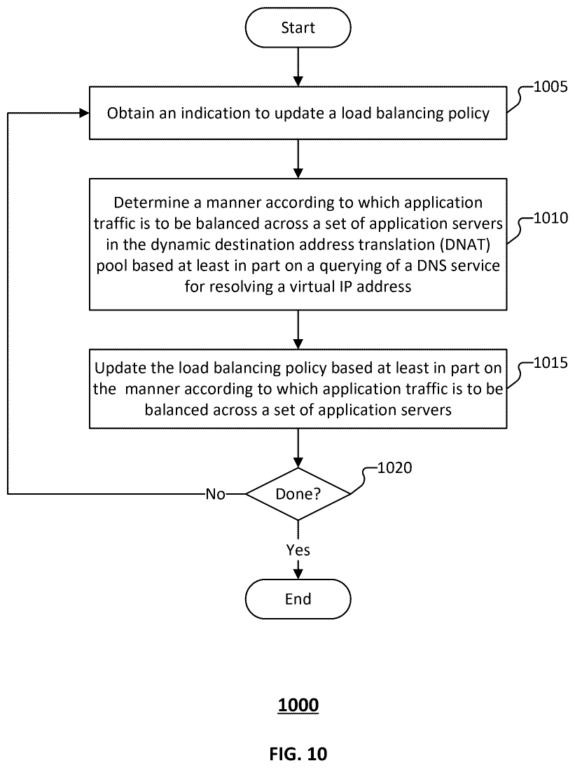

FIG. 10 is a flow diagram of a method for updating a load balancing policy for handling application traffic across a plurality of application servers according to various embodiments.

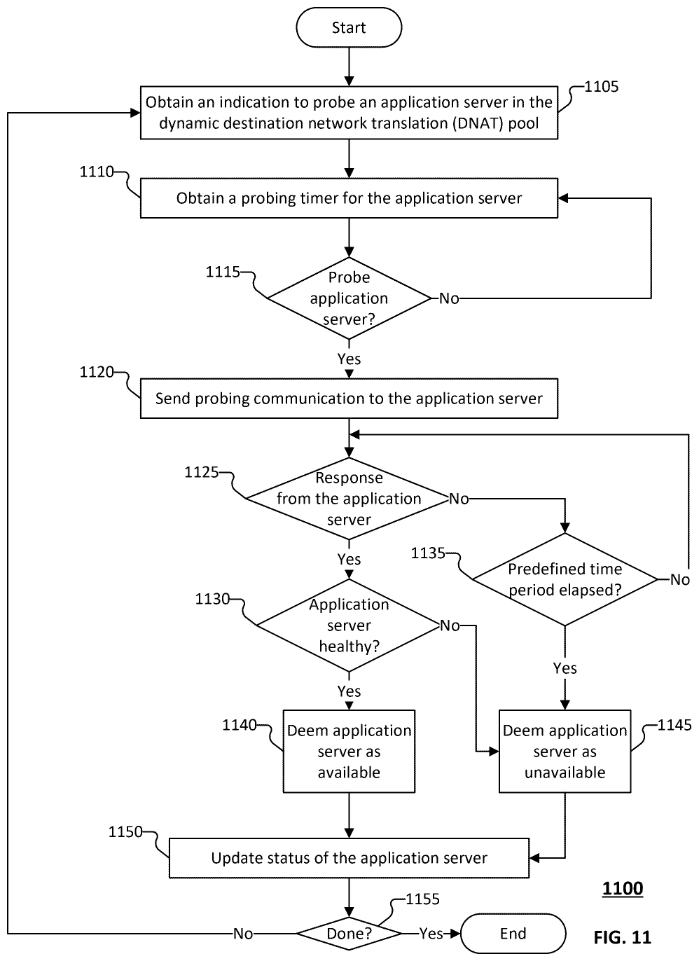

FIG. 11 is a flow diagram of a method for probing a status of an application server according to various embodiments.

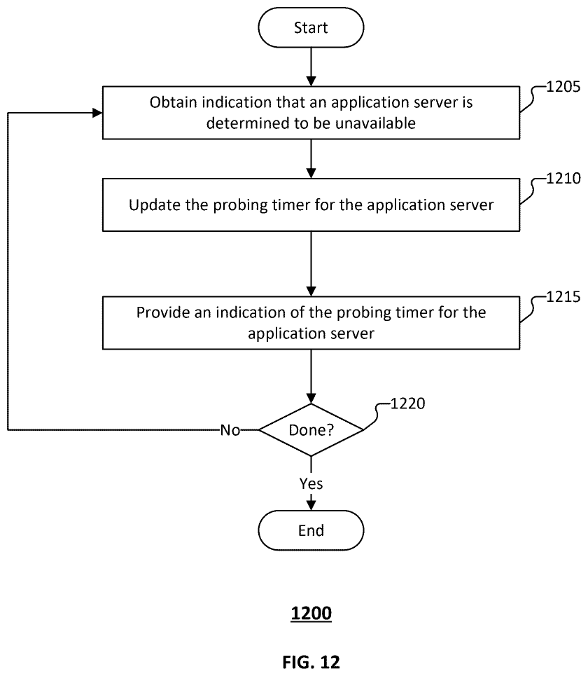

FIG. 12 is a flow diagram of a method for updating a probing timer for an application server according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a physical address for an application server may correspond to a data center IP address. This data center IP address may be a private IP address space, such as defined by RFC 1918 address allocations.

Enterprise networks (e.g., customer or tenants of a security service) can comprise an application identified by a Fully Qualified Domain Name (FQDN) running in a data center for the network (e.g., a data center for the customer, tenant, etc.). In some instance, the enterprise networks mostly have DNS servers resolving the FQDN of this application. Furthermore, this application is served by multiple endpoints or a server farm, such as a set of application servers. A query to the DNS server can resolve to one or multiple IP addresses in order to load balance the future sessions to these application servers. This is usually common practice to do load balancing using DNS queries.

In enterprise networks implementing a solution like Zero Trust Network Access (ZTNA) connector, the access to the application is usually behind a network address translation (NAT) router between the client system and the set of application servers providing the application service (e.g., the set of application servers to handle application traffic).

In some embodiments, the connectivity between a client (e.g., a client system for a user, such as a laptop device) to the application handled by a set of application servers in the data center is through the fabric for a security service. The domain controller IP address space is private and is not routable from the client via the fabric. The client does not directly communicate with the DNS server but instead relies on the DNS proxy in a management unit (MU) gateway serving the FQDN resolutions. This DNS Proxy serves out a virtual IP address which is routable in the fabric. The packets destined to virtual IP address reaches the ZTNA node (e.g., a ZTNA connector) and then the virtual IP address gets translated to an application server IP address which belongs to the domain controller IP address space. In some embodiments, the system implements NAT functionality on the ZTNA node (e.g., the ZTNA connector which connects traffic for a virtual IP address to a particular application server). The system can thus separate out the domain controller IP address space from the network fabric space.

When the network infrastructure hosts the application service behind a network (e.g., a ZTNA node), the client is not directly communicating with the DNS server, and this topology breaks the DNS server load balancing. In such a topology, the NAT router or connector can perform FQDN resolution and a static DNAT entry is created based on the resolved Ip address of the application. Creation of static NAT entry breaks the DNS load balancing mechanism. By virtue of static DNAT entry, all the future sessions to the application will be sent out to only one application server as long as that server is responding to the probe and DNS server is resolving the FQDN to the IP address for that application server. If that application server is not available or healthy (e.g., the application server is not responding to a status probe) and if DNS resolves to another IP address, the NAT router will use the second IP address but only use the second one and load all new sessions to the second server again breaking the load balancing intended by the DNS server.

According to various embodiments, the system mimics DNS load balancing logic for an application hosted behind a ZTNA node. The system manages/updates a dynamic DNAT pool to direct application traffic across the set of application servers according to a load balancing that is determined based on a DNS re-resolution (e.g., a DNS probing) and/or an application server proving (e.g., a probing of the application server status/availability). The system receives a request from a client system for a connection to an application service via an application port (e.g., a port having an virtual IP address that can be resolved to a set of application servers). A connector determines which of a set of application servers is to be used to handle the traffic for the client system query/connection.

Various embodiments provide a method, system, and computer system for providing intelligent DNS load balancing using a combination of a dynamic DNAT pool and application providing in a connector-based solution for private application access. The method includes: (a) performing a DNS re-resolution (e.g., a DNS probing) for resolving an application Fully Qualified Domain Name (FQDN) to obtain a plurality of IP addresses for a plurality of application servers, (b) performing periodic application server probing, and (c) dynamically updating a destination network address translation (DNAT) to provide DNS load balancing for application traffic. The DNAT is updated based at least in part on one or more of the DNS re-resolution and the application server probing.

In some embodiments, the system by default implements an equal weighting for load balancing application traffic across a set of application servers, subject to redistribution of an unavailable/unhealthy application server(s). For example, in response to determining that an application server is unhealthy/unavailable, the system redistributes or rebalances the allocation of new application traffic (e.g., application traffic for new sessions) across the set of healthy/available application servers of the set of application servers. In some embodiments, the system can additionally redistribute the current allocation of application traffic across the set of healthy/available application servers of the set of application servers. In some embodiments, if the DNS service returns an SRV record for the set of application servers, the system load balances the application traffic across the set of application servers based on the weightings comprised in the SRV record.

Various embodiments provide s intelligent DNS load balancing using the combination of various techniques. The system achieves the load balancing as instructed by the DNS service (e.g., the DNS server) for these DNS proxy kinds of networks. The system can remain in close synchronization with the load balancing DNS server. The use of a dynamic/intelligent DNAT enables the system to minimize load on DNS server queries. In some embodiments, the load balancing implemented by the system takes into consideration the health of the application server (e.g., which can be determined via periodic/regular application server probing). In some embodiments, the DNAT and/or load balancing application traffic across the set of application servers is autonomous and self-adjusting based on the dynamics of the network and application availability.

FIG. 1 is a block diagram of an environment for load balancing application traffic across one or more application servers according to various embodiments. In some embodiments, system 100 implements one or more of system 200 of FIG. 2 and/or system 300 of FIG. 3. In some embodiments, system 100 implements one or more of processes 400-1200 of FIGS. 4-12.

Various embodiments combine DNS resolution with application probing and dynamically programming DNAT entries (e.g., dynamically updating a DNAT pool) on a connector (e.g., a ZTNA node that connects a client system with an application service provided by a set of application servers) to achieve the load balancing that a DNS server is trying to indicate even when NAT is present.

In some embodiments, the connectivity between a client (e.g., a client system for a user, such as a laptop device) to the application handled by a set of application servers in the data center is through the fabric for a security service. The domain controller IP address space is private and is not routable from the client via the fabric. If there is an application hosted by set of three application servers and a DNS server behind a ZTNA connector (e.g., an NAT router). From a client system perspective (e.g., a user's point of view), the application is behind a single virtual IP address that is different from the private data center IP range.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains, DNS hijacked domains, or stockpiled domains, or such as traffic for certain applications (e.g., SaaS applications). In some embodiments, data appliance 102 is also configured to enforce policies with respect to traffic that stays within (or from coming into) enterprise network 110.

In some embodiments, data appliance 102 is a security entity, such as a firewall (e.g., an application firewall, a next generation firewall, etc.). An enterprise network (e.g., a network for a tenant serviced by security platform 140) may comprise a set of data appliances 102 (e.g., a set of remote network nodes).

Firewalls typically deny or permit network transmission based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QOS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content-not just ports, IP addresses, and packets-using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provide higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™ Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

Techniques described herein can be used in conjunction with a variety of platforms (e.g., desktops, mobile devices, gaming platforms, embedded systems, etc.) and/or a variety of types of applications (e.g., Android.apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including mediating traffic to an application service (e.g., to provide access to the application service behind an enterprise network or authentication service), performing a DNS re-resolution, performing an application server probing, performing a dynamic DNAT pool update/management securing code, performing a load balancing policy updating or providing a load balancing of application traffic across a set of application servers configured (e.g., assigned/allocated to handle the application traffic), or various other security services for network traffic, such as real-time or contemporaneous classifications, or offline classifications. The various other security services may include securing a code base, classifying domains (e.g., predicting whether a domain is a DNS hijacked domain, etc.), classifying network traffic, providing a mapping of signatures to certain domains (e.g., domains for which a predicted likelihood that the domain is a DNS hijacked domain exceeds a predefined likelihood threshold, etc. a mapping of domains to domain data (e.g., domain certificates, pDNS data, active DNS data, WHOIS data, etc.), performing static and dynamic analysis on malware samples, monitoring new domains (e.g., detecting new domains for which a certificate is issued/generated), assessing maliciousness of domains, determining whether a domain associated with a traffic sample is (or is likely to be) a DNS hijacked domain, providing a list of signatures of known exploits (e.g., malicious input strings, malicious files, malicious domains, etc.) to data appliances, such as data appliance 102 as part of a subscription, detecting exploits such as malicious input strings, malicious files, or malicious domains (e.g., an on-demand detection, or periodical-based updates to a mapping of domains to indications of whether the domains are malicious or benign), providing a likelihood that a domain is malicious (e.g., a parked domain, a DNS hijacked domain) or benign (e.g., an unparked domain), providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, or domains are malicious, providing an indication that an input string, file, or domain is malicious (or benign), simulating DNS hijacking attacks/campaigns (e.g., generating synthetic DNS hijacking records), and training classifiers (e.g., training machine learning models, such as to be used to provide inline detection of DNS hijacked domains, or offline detection of DNS hijacked domains).

In some embodiments, security platform 140 is deployed as a cloud service. For example, security platform 140 may be implemented by one or more servers and may comprise one or more clusters of worker nodes (e.g., virtual machines).

In some embodiments, security platform 140 (e.g., malicious traffic detector 138) classifies the network traffic, files, or domains in response to receiving a network traffic sample or according to a predefined schedule. For example, security platform 140 can perform the classification as the endpoint or network entity (e.g., a firewall or data appliance 102) detects traffic for a new domain, traffic to/from a suspicious domain, a new file, etc. In various embodiments, results of analysis (and additional information pertaining to applications, domains, etc.), such as an analysis or classification performed by security platform 140, are stored in database 160. In the example shown, malicious traffic detector comprises a DNS tunneling detector, a malicious file detector, a malicious domain detector, etc., each providing a different malicious traffic detector service.

In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

In the example shown, security platform 140 comprises malicious traffic detector 138. Malicious traffic detector can classify network traffic in real-time (e.g., contemporaneous with a firewall, such as data appliance 102 receiving such traffic) or offline (e.g., to generate whitelists or blacklists, etc.). As illustrated, malicious traffic detector 138 can comprise a DNS tunneling detector, a malicious file detector, or a malicious domain detector (e.g., to predict whether a domain is malicious or hijacked, etc.). Malicious traffic detector 138 may implement one or more classifiers, such as machine learning models, to predict the classifications. Additionally, malicious traffic detector 138 may train the machine learning model(s) to perform the classifications. According to various embodiments, security platform 140 may perform various other security services.

Security platform 140 causes the suspicious domains to be proactively classified (e.g., before traffic to/from the suspicious domains is intercepted by a network security entity) by malicious traffic detector or another service. In response to obtaining the domain classifications, security platform 140 can proactively update whitelists or blacklists, as applicable, to comprise the domain classifications.

Security platform 140 comprises dynamic DNAT service 170. Dynamic DNAT service 170 can dynamically update a DNAT for application traffic destined for a virtual IP address associated with an application to a set of application servers that are configured (e.g., assigned/allocated) to handle application traffic. Additionally, dynamic DNAT service 170 may perform a load balancing of application traffic across the set of application servers. As shown, dynamic DNAT service 170 can comprise DNS re-resolution service 172, application server probing service 174, DNAT pooling service 176, and/or load balancing service 178.

Dynamic DNAT service 170 uses DNS re-resolution service 172 to probe a DNS service (e.g., to send DNS queries to a DNS service) for resolving the FQDN for an application to one or more IP addresses for a set of one or more application servers that are configured to handle application traffic for the application. In some embodiments, DNS re-resolution service 172 periodically probes the DNS service. For example, the DNS re-resolution service 172 probes the DNS service according to a predefined frequency and/or based at least in part on a TTL of a previous DNS query response (e.g., a previous response to the DNS re-resolution provided by the DNS service).

Dynamic DNAT service 170 uses application server probing service 174 to probe the health of one or more application servers identified in the DNS re-resolution service. For example, the application server probing service 174 can independently probe each application server in the set of application servers configured to handle the application traffic to determine the availability or health of the application servers. Based on the application server probing, application server probing service 174 determines whether a particular application server is available (e.g., healthy) or unavailable (e.g., unhealthy).

Dynamic DNAT service 170 uses DNAT pooling service 176 to dynamically update/manage a DNAT pool of a set of application servers across which application traffic is to be distributed/handled. DNAT pooling service 176 can update a DNAT pool based at least in part on the results of the DNS re-resolution and/or the application server probing. For example, DNAT pooling service 176 updates the DNAT pool to include those application servers identified by the most recent DNS re-resolution response (e.g., a current response to a DNS probing). As another example, DNAT pooling service 176 updates the DNAT pool to comprise only those application servers that are currently determined to be available (e.g., healthy) from among the set of application servers identified in the current DNS re-resolution response.

Dynamic DNAT service 170 uses load balancing service 178 to determine how application traffic or application sessions are to be distributed across the set of application servers. Load balancing service 178 may determine a load balancing to be implemented based at least in part on the current DNS re-resolution response. For example, load balancing service 178 determines the load balancing on a set of weightings for the set of application servers determined based at least in part on the current DNS re-resolution response. The set of weightings may be expressly enumerated in the DNS re-resolution response, such as in the case that the DNS service returns an SRV record. Alternatively, the set of weightings may be inferred from the DNS re-resolution response. For example, if the DNS re-resolution response does not expressly enumerate the set of weightings, load balancing service 178 deems the set of application servers to be equally weighted. Load balancing service 178 load balances the application traffic or application sessions based on the weightings and/or the current availability (e.g., health status) for the various application servers in the set of application servers configured to handle application traffic.

A system administrator configures an application service by onboarding the application in the form of FQDN+Port(s)+Protocol. The system administrator can optionally specify the type of probing that the application connector (e.g., a ZTNA connector or connector service) to perform with respect to the application, for example, TCP, UDP, none, or ICMP.

According to various embodiments connector knows about the DNS server IP address during the initial bring up step using DHCP. The connector obtains the configuration from the controller about the application FQDN in the data center. This configuration can be admin controlled whenever an application is onboarded to the connector (e.g., ZTNA connector). In response to being so configured, the connector (e.g., the connector service such as implemented by a ZTNA connector) starts DNS re-resolution which periodically resolves the application FQDN. Based on the DNS re-resolution, the connector obtains the IP addresses for a set of application servers resolved for the application FQDN. For example, the connector learns the 3 IP addresses of the application servers served by the DNS server. A DNS server can respond with one or more IP addresses in its response to the DNS re-resolution. The response can be of Type A record or SRV records. As an example, the DNS request is either an A record request or an SRV record request the response from the DNS server matches the request. Accordingly, the the option to provide the weighted load balancing can actually based on the original DNS request being A or SRV. Various other response types may be implemented, and the various response types may or may not have an explicit weighting for the application servers for implementation of a load balancing of application traffic across the set of application servers. As an example, the response to an SRV record is a list of fqdns with A records attached. Those A records will not map to multiple addresses. The response comprises one address per fqdn A record within an srv response. According to various embodiments, the load balancing comprises (a) a record request with multiple addresses in the response is equally load balanced, or (b) an SRVrequest with multiple fqdns and weights with each fqdn having a single IP address.

In some embodiments, the connector implements an application server probing. Before the connector serves the application traffic from the client (e.g., the user) to the application, the connector determines (e.g., finds) the health or availability for the application servers in the set of application servers (e.g., for each of the 3 application servers in the example used above). The health/availability of the application server can be derived from the application probing on each of the application servers. In some embodiments, in response to determining (e.g., obtaining/learning) the IP addresses for the application servers in the set of application servers from the DNS response (e.g., the response for the DNS re-resolution), the connector initiates the application server probes (e.g., a TCP 3-way handshake) on the configured port to each of the IP addresses for the application servers (e.g., the IP addresses identified based on the DNS response). Based on the responses to the application server proving, the connector determines which application servers are healthy and ready/available to serve (e.g., handle) the application traffic.

In some embodiments, the system implements a dynamic DNAT pool formation. For example, the system dynamically manages/updates a DNAT pool based at least in part on the results from the DNS re-resolution and/or the application server proving. All of the existing system relies on the static DNAT pool for doing destination NAT to the application server. Various embodiments create the DNAT pool and dynamically update the DNAT pool by combining the health of the application server(s). Depending on the application probes, the system (e.g., the connector) creates the pool of destination IP addresses ready/available to serve (e.g., handle) the application traffic.

In some embodiments, the system (e.g., the connector) configures/installs the DNAT rules only for the pools of IP addresses which are found to be healthy or available. For example, the system configures the DNAT pool to only include the application servers determined to be healthy/available from among the set of application servers identified based on the DNS re-resolution. The system can update/configure the DNAT pool automatically and dynamically on the connector, etc.

Additionally, the rules may be programmed in connector data path in such a way that each new session is automatically load balanced across only the healthy/available application servers.

Various embodiments implement a predetermined algorithm based on the number of application servers found to be healthy/available after DNS resolution The weighting of each server can be determined based on the response to the DNS re-resolution. For example, the weighting can be expressly enumerated in the response to the DNS re-resolution. Alternatively, the weighting can be inferred from the response to the DNS re-resolution, for example, by deeming the weighting to be equally distributed across the set of application servers if the DNS response does not enumerate an express weighting (e.g., if an SRV record is not received in response to the DNS re-resolution).

As an illustrative example, the DNS service may resolve the FQDN to three server IP addresses (e.g., three application servers are identified in the resolving by DNS query). No weightage information is available. If all three application servers are healthy after application probing, then the system configures (e.g., updates) the dynamic DNAT pool to comprise the three IP addresses for these three application servers. Based on the current dynamic DNAT pool configuration, the new session load is evenly distributed across these three application servers. For example, 33.33% of all new sessions are given to each of the three IP addresses for the application servers to handle the application traffic. In some embodiments, the load balancing is implemented in iptable rule programming and using the statistics module of an iptable library.

As another illustrative example, the DNS service may resolve the FQDN to three server IP addresses (e.g., three application servers are identified in the resolving by DNS query). No weightage information is available. If only two application servers are healthy/available (e.g., based on the response(s) from the application server probing), then the system configures/updates the dynamic DNAT pool to include only the two IP addresses for the two healthy/available application servers. Based on the current dynamic DNAT pool configuration, the new session load is evenly distributed across these three application servers, for example with 50% of the sessions (e.g., the application traffic) distributed to each of the two healthy/available application servers.

In some embodiments, the probing (e.g., DNS re-resolution and application server probing) and load balancing is continuous. For example, the system (e.g., the connector) periodically repeats the DNS re-resolution, the application server probing, and the updating of the dynamic DNAT pool (e.g., for determining the load balancing). As an example, the system continuously learns about the current status of the network. During the probing, if the system (e.g., the connector) finds a change in the number of application server IP addresses, or health of each application server, the system correspondingly adjusts the dynamic DNAT pool.

In some embodiments, if none of the application servers are responding to the application server proving, the system (e.g., the connector) withdraws the application route and no longer participates in attracting the application traffic towards itself. However, whenever the probe succeeds again, the system can again advertise the route and starts the load balancing as described above.

DNS responses have an associated time to live (TTL) associated. The TTL is an indication to the client (or the connector service) on how long to cache the resolved entry (e.g., the resolved IP addresses for the set of application servers), which upon expiry of the TTL the client should redo the resolution. As an example, when the TTL expires, the cache entry is removed and the re-resolution can be performed the next time the client accesses the same fqdn. As another example, when the TTL expires, the system triggers a re-resolution such as to obtain a new A or SRV record content for load balancing. This is needed for two purposes: (a) to reduce the load on DNS server by reducing frequent queries from the same client, and (b) to achieve time based load balancing of the application servers. As an example, the system may load a first server for 5 minutes until the TTL expires, load a second server for a next 5 min until the next TTL expires.

In some embodiments, the system (e.g., the DNS probe module on the connector) can use this TTL to adjust its DNS re-resolution dynamically. Accordingly, the system can combine the TTL with probing of the DNS service (e.g., the DNS server) to properly load balance application traffic.

The response to a DNS re-resolution may include a type A record (e.g., based on the DNS request being a type A request), which are the most common form of DNS records. A type A record indicates the FQDN to IP address mapping for the DNS query. In such records the load sharing or port or protocol information is not available. In this case, the system uses only the IP addresses for the application servers comprised in the record in connection with updating a DNAT pool and load balancing application traffic. If the DNS response (e.g., the type A record) comprises multiple IP addresses, the system treats the corresponding application servers equally (e.g., the system equally distributes/load balances application traffic or sessions across the set of application servers). For example, if all IP addresses or application servers identified in the DNS query response are determined to be healthy or available, the application servers are equally load balanced.

Alternatively, the response to a DNS re-resolution may include an SRV record (e.g., based on the DNS request being an SRV request). A SRV record can comprise more information about the application servers. For example, the SRV record can comprise information pertaining to the port and protocol of the application server. Additionally, the SRV record may comprise records including information for a plurality of application servers. The SRV record returned by the DNS service in response to the DNS re-resolution may also comprise load sharing weightages and priorities for each server. As an illustrative example, an SRV response may comprise four server records. The SRV response can indicate the IP address of each application server and further indicate the weighting of each server: a first application server weighting=40%; a second application server weighting=20%; a third application server weighting=20%; and a fourth application server weighting=20%.

In response to receiving an SRV record based on the DNS re-resolution, the system (e.g., the connector) does the health check (e.g., performs an application server probing) for an application server, for example, for each of the application server associated with each IP address included the record. Based on the health checks (e.g., the application server probing) the system determines which application servers are healthy (e.g., available to handle application traffic) and are candidates for dynamic DNAT pool. However, when a dynamic DNAT pool is formed from these application servers deemed to be healthy/available, the weightage indicated in the SRV record is considered. For example, when all servers are healthy, the system programs the iptables rules or dynamic DNAT rules with the indicated weightages of 40-20-20-20 respectively. However, if the third application server is determined to not be healthy/available, the system distributes the 20% weighting for the third application server among the other remaining application servers according to their own weightings (e.g., the allocation for any unhealthy/unavailable application servers is distributed pro rata across the remaining healthy/available application servers based on their respective weightings). In this illustrative example, the first application server is allocated an additional 10% (e.g., the first application server is assigned twice as much as the second application server and the fourth application server; so, the original 20% weighting for the third application server being redistributed is by 2); and the second application server and fourth application server are each allocated an additional 5%. Accordingly, in this illustrative example, the system updates the dynamic DNAT pool to comprise a distribution of: first application server: 50%; second application server: 25%; third application server: absent/none; and fourth application server: 25%.

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In various embodiments, when a client device (e.g., client device 104) attempts to resolve an SQL statement or SQL command, or other command injection string, data appliance 102 uses the corresponding domain (e.g., an input string) as a query to security platform 140. This query can be performed concurrently with the resolution of the SQL statement, SQL command, or other command injection string. As one example, data appliance 102 can send a query (e.g., in the JSON format) to a frontend 142 of security platform 140 via a REST API. Using processing described in more detail below, security platform 140 will determine whether the queried SQL statement, SQL command, or other command injection string indicates an exploit attempt and provide a result back to data appliance 102 (e.g., “malicious exploit” or “benign traffic”).

In various embodiments, when a client device (e.g., client device 104) attempts to open a file or input string that was received, such as via an attachment to an email, instant message, or otherwise exchanged via a network, or when a client device receives such a file or input string, DNS module 134 uses the file or input string (or a computed hash or signature, or other unique identifier, etc.) as a query to security platform 140. In other implementations, an inline security entity queries a mapping of hashes/signatures to traffic classifications (e.g., indications that the traffic is C2 traffic, indications that the traffic is malicious traffic, indications that the traffic is benign/non-malicious, etc.). This query can be performed contemporaneously with receipt of the file or input string, or in response to a request from a user to scan the file. As one example, data appliance 102 can send a query (e.g., in the JSON format) to a frontend 142 of security platform 140 via a REST API. Using processing described in more detail below, security platform 140 will determine (e.g., using a malicious file detector that may use a machine learning model to detect/predict whether the file is malicious) whether the queried file is a malicious file (or likely to be a malicious file) and provide a result back to data appliance 102 (e.g., “malicious file” or “benign file”).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is a block diagram of an environment for load balancing application traffic across one or more application servers according to various embodiments. In some embodiments, system 200 is implemented at least in part by system 100 of FIG. 1. In some embodiments, system 200 implements one or more of processes 400-1200 of FIGS. 4-12.

In the example shown, system 200 comprises an application traffic connection service 230 (e.g., a Zero Trust Network Access (ZTNA) connector), which queries DNS service 240 to resolve the FQDN for the application to obtain from DNS service 240 an indication of one or more IP addresses for one or more application servers. System 200 further comprises a set of application servers 250 to provide an application service for network 210 (e.g., for an enterprise network). The set of application server 250 comprise server 1 252, server 2 254 and server 3 256.

Access to an application (e.g., an application service provided by a set of application servers) is behind a ZTNA node. In some embodiments, the IP address for the application is hidden from the user's perspective. The address range of application servers is a private IP address which is specific to an enterprise network (e.g., a customer environment). However, when the application service is located behind the ZNTA node (e.g., the application traffic connection service 230) the load balancing according to traditional load balancing techniques is not feasible. For example, if an application is hosted in the set of application servers 250 (e.g., server 1 252, server 2 254 and server 3 256), system 200 (e.g., application traffic connection service 230) independently determines an IP address for each query for the application service (e.g., to serve a different IP address for each query). Because access to the application service is hidden behind a single IP address (e.g., a virtual IP address associated with the application service which is then resolved to the set of application servers 250), system 200 cannot match the DNS load balancing logic behind the ZTNA node.

According to various embodiments, the system (e.g., system 300) mimics DNS load balancing logic for an application hosted behind a ZTNA node. The system manages/updates a dynamic DNAT pool to direct application traffic across the set of application servers according to a load balancing that is determined based on a DNS re-resolution and/or an application server probing (e.g., a probing of the application server status/availability). The system receives a request from a client system for a connection to an application service via an application port (e.g., a port having an virtual IP address that can be resolved to a set of application servers). A connector determines which of a set of application servers is to be used to handle the traffic for the client system query/connection.

FIG. 3 is a block diagram of an environment for load balancing application traffic across one or more application servers according to various embodiments. In some embodiments, system 300 is implemented at least in part by system 100 of FIG. 1. In some embodiments, system 300 implements one or more of processes 400-1200 of FIGS. 4-12.

In the example shown, system 300 comprises an application traffic connection service 330 (e.g., a Zero Trust Network Access (ZTNA) connector) and a dynamic DNAT pool 335. The dynamic DNAT pool 335 may be comprised in application traffic connection service 330 or at a remote storage that is accessible to application traffic connection service 330. The application traffic connection service 330 maps application traffic to a set of application servers 350 such as by updating the dynamic DNAT pool 335.

Access to an application (e.g., an application service provided by a set of application servers) is behind a ZTNA node. In some embodiments, the IP address for the application is hidden from the user's perspective. The address range of application servers is a private IP address which is specific to an enterprise network (e.g., a customer environment). However, the load balancing according to traditional load balancing techniques is hidden behind the ZNTA node (e.g., the application traffic connection service 330)

In some embodiments, the application traffic connection service 330 performs a DNS re-resolution for resolving an application Fully Qualified Domain Name (FQDN) to obtain a plurality of IP addresses for a plurality of application servers. As illustrated, application traffic connection service 330 probes DNS service 340 to resolve an address corresponding to application traffic, such as to obtain one or more IP addresses for a set of application server(s) that are assigned/allocated to handle application traffic (e.g., certain traffic to a particular domain associated with an application or SaaS service, etc.). In the example shown, in response to application traffic connection service 330 performing a DNS re-resolution to resolve an application FQDN, DNS service 340 provides an indication that the application FQDN is resolved to a set of application servers comprising server 1 352, server 2 354, and server 3 356. Application traffic connection service 330 can periodically perform the DNS re-resolution, such as according to a predefined frequency. Additionally, or alternatively, the application traffic connection service 330 performs the DNS re-resolution based on a time to live (TTL) of the response from the DNS service for the previous iteration/cycle of the DNS re-resolution.

In some embodiments, in response to receiving a DNS re-resolution query, DNS service 340 provides an indication of the set of application servers across that are configured to handle the application traffic, for example, a set of application servers assigned or allocated to handle the application traffic. DNS service 340 may additionally provide (e.g., in the case that DNS service 340 provides an SRV record in response to the DNS re-resolution query, such as in response to a query that is an SRV query) an indication of weightings for each server, such a set of weightings to be used in connection with load balancing application traffic across the set of application traffic. In some embodiments, in the absence of an indication of the weightings for the set of application servers, application traffic connection service 330 deems the application servers to be equally weighted for load balancing purposes. DNS service 340 may additionally provide an indication of the TTL for the response to the current DNS re-resolution (e.g., the TTL for which the assignment/allocation of the set of application servers for the application traffic is to be deemed valid).

In response to receiving the response to the DNS re-resolution (e.g., one or more of an indication of a set of application servers assigned/allocated to handle the application traffic, and/or a set of weightings for the set of application servers), application traffic connection service 330 stores an indication of the set of application servers to be used to handle application traffic, such as in a mapping of application traffic to application servers or a DNAT. In some embodiments, application traffic connection service 330 manages/updates a dynamic DNAT pool of application servers for a particular application traffic. As an example, in response to receiving the response to the DNS re-resolution, application traffic connection service 330 dynamically updates the DNAT pool to reflect that the set of application servers identified in the DNS re-resolution response are to handle the application traffic.

In some embodiments, in addition to updating the DNAT pool to reflect the set of application servers identified in the most recent DNS re-resolution, application traffic connection service 330 can store an indication of weightings to be assigned to the set of application servers, such as a weighting to be used to load balance application traffic across the set of application servers identified in the DNAT pool. As an example, if the DNS service 340 provides a SRV record or the like in response to the DNS re-resolution, application traffic connection service 330 can obtain a set of weightings for the set of application servers from the SRV record and store the weightings in association with the set of application servers. As another example, if the DNS service 340 does not provide a SRV record or otherwise expressly provide an indication of the weightings for the set of application servers, application traffic connection service 330 deems the weightings to be equal and can correspondingly store the equal weightings in association with the set of application servers.

The weightings for the set of application servers may be stored in the DNAT pool, for example, in a table that maps application traffic to a set of application servers and corresponding weightings. Additionally, the table may store a field that maps an application server to a current application status (e.g., availability, health status, etc.).

According to various embodiments, application traffic connection service 330 performs an application server probing such as to assess the availability or health status of the set of application servers. The application traffic connection service 330 can perform the application server probing in accordance with a predefined frequency, such as by using a predefined application probing timer to identify when to next invoke the application server probing. A plurality of application servers may have corresponding independent probing timers. In some embodiments, each server within the set of application servers has an associated independent probing timer (e.g., a timer that is independent of a probing timer for a different application server within the set of application servers). Application traffic connection service 330 may receive a response from a particular application server that indicates whether the application server is available (e.g., healthy) or unavailable (e.g., unhealthy). Alternatively, application traffic connection service 330 may deem a response from the application server as being indicative of the availability the application server (e.g., that the application server is healthy), and may deem a lack of response (e.g., after a predefined response time interval) to be indicative of the unavailability of the application server (e.g., that the application server is not healthy).

In some embodiments, the probing timer associated with an application server is dependent on an availability or health status of the application server. For example, the probing timer for an available/healthy application server may be longer than the probing timer for an unavailable/unhealthy application server. Application traffic connection service 330 may configure the probing timer based on a most recent determination of whether the application server is available/health (e.g., the result from the most recent application server probing). In some embodiments, application traffic connection service 330 more frequently performs the application server probing with respect to a particular application server in response to a determination that the particular application server is not healthy. The probing timer associated with a particular application server (e.g., a predefined time interval) for the periodic application server probing is between one minute and five minutes.

In response to determining whether an application server is available/healthy (e.g., in response to determining the results of the most recent application server probing), application traffic connection service 330 can store an indication of the application server status, such as in the DNAT pool (e.g., the table comprising a mapping the application traffic server to the set of application servers to the application server statuses, etc.). In some embodiments, the DNAT pool comprises a status field in association with a particular application server, and application traffic connection service 330 stores the application server status (e.g., available/unavailable, or healthy/unhealthy) for the particular application server in the status field. In other implementations, application traffic connection service 330 directly updates a weighting assigned to the particular application server based on the application server status, for example, by using the weighting determined based on the most recent DNS re-resolution results for an application server deemed available (e.g., healthy), and using a null weighting (e.g., a weighting of zero) for an application server deemed unavailable (e.g., unhealthy). As an illustrative example in which the application traffic connection service 330 determines to equally weight the set of application servers based on the DNS re-resolution results, in response to a determination that an application server identified in a current DNAT pool is not available to handle at least a subset of the application traffic, application traffic connection service 330 distributes new application traffic across the healthy servers of the plurality of application servers (e.g., application traffic for new sessions is load balanced according to the redistribution to the remaining healthy application servers).

In some embodiments, system 300 programs (e.g., application traffic connection service 330 defines) a set of DNAT rules in a connector path in a manner that each new session is automatically load balanced across healthy application servers from among the plurality of applications servers identified from a most recent DNS re-resolution.

Application traffic connection service 330 load balances application traffic across the set of application servers, and in particular, across the healthy application servers of the set of application servers. Application traffic connection service 330 provides an indication of an application server (e.g., an IP address for the application server) to handle particular application traffic. In response to receiving application traffic, application traffic connection service 330 determines an application server to be used to handle such application traffic based on the current load balancing policy, for example, based on a current weightings for the set of application servers (or current relative weightings for the set of healthy application servers that is a subset of the set of application servers).

As an illustrative example, an SRV record obtained based on the DNS re-resolution indicates that the application traffic can be handled by 4 servers (e.g., the SRV response comprises 4 server records) and the weightings are 40% for the first server, 20% for the second server, 20% for the third server, and 20% for the fourth server. After application traffic connection service 330 obtaining an SRV record (e.g., in response to the DNS re-resolution), application traffic connection service 330 performs the application server proving (e.g., the health probing) for each of the server IP in the record and determines which of those four servers are healthy and are candidates for dynamic DNAT pool. Accordingly, when all servers are healthy, the iptables rules or Dynamic DNAT rules (e.g., the DNAT pool) will be programmed with the indicated weightages of 40-20-20-20 respectively. However, if the third server is determined to be unavailable/not healthy, application traffic connection service 330 redistributes the 20% weightage for the third server among the other remaining 3 servers according to their own weightage. In this case, the first server will get an additional 10% (e.g., the first server is assigned twice as much as the second server and the fourth server; so application traffic connection service 330 divides the 20% for the third server by two) while second server and the fourth server will each be assigned an additional 5% (e.g., the additional assignment is determined based on the particular application server weighting divided by the sum of the total weightings for all healthy application server). The dynamic pool distribution will thus be: first server=50%; second server=25%; third server=absent/unavailable; and fourth server=25%.

In some embodiments, system 300 further comprises a network 310 (e.g., an enterprise network) via which client system 305 connects to interact with the application. Client system 305 accesses the network 310 via gateway service 312. For example, client system 305 requests access to the application or requests the application service by connecting to the network 310 via gateway service 312. Gateway service 312 can authenticate the user associated with client system 305 to ensure that client system 305 has permission to access the network 310 and/or to access the application service. In response to authenticating the user (e.g., determining that the client system 305 can connect to the application service), system 300 determines the application server (e.g., the IP address for the application server) to handle the application traffic to provide the application service to client system 305. System 300 determines the application service based on querying the DNAT pool 335 and/or a load balancing policy to assign the application traffic based on the predetermined weightings. The application traffic for client system 305 is then mediated/directed to the selected (available/healthy) application server from among the set of application servers 350.

System 300 may further comprise ZTT service 314. ZTT service may be a ZTNA tunnel terminator. As an example, ZTT service 314 is a node in network where application traffic connection service 330 (e.g., a ZTNA connector) terminates the IPSec Tunnel. ZTT service 314 and application traffic connection service 330 can together provides the secure IpSec Tunnel based connectivity to an application hosted in a set of servers (e.g., a customer's private datacenter).

System 300 may further comprises ZTNA microservice 320. ZTNA microservice 320 may serve as the control/management plane entity. For example, ZTNA microservice 320 controls the configuration of various other components of the solution. ZTNA microservice 320 can take in the user intent and converts to the various configurations objects needed for each part of the system to function properly.

In response to receiving the request for an application service from client system 305, gateway service 312 receives an indication from application traffic connection service 330 of a selected application server or an indication of the DNAT according to the dynamic DNAT pool 335 and/or the current load balancing policy.

In some embodiments, DNAT pool 335 is comprised in application traffic connection service 330 or in a datacenter, such as a router hosted for a customer (e.g., a customer having traffic that accesses the application service). Application traffic connection service 330 can query DNAT pool 335 and determine the address with which the application is to be accessed/communicated and application traffic connection service 330 correspondingly selects the communication path and destination.

In some embodiments, one or more of processes 400-1200 are invoked by a system or service that is configured to manage a dynamic DNAT pool of application servers across which application traffic is to be load balanced and/or to load balance application traffic across a set of application servers. For example, process 400 is invoked to perform an update dynamic DNAT pool with a set of application servers to handle application traffic, and optionally, to include an indication a current status of the application servers.

FIG. 4 is a flow diagram of a method for dynamically updating a destination network address translation (DNAT) according to various embodiments. In some embodiments, process 400 is implemented at least in part by system 100 of FIG. 1 and/or system 300 of FIG. 3. Process 400 may be implemented by an upstream device such as a worker node, a virtual machine, etc.

At 405, the system performs a DNS re-resolution for resolving an application Fully Qualified Domain Name (FQDN) to obtain a plurality of IP addresses for a plurality of application servers. In some embodiments, application traffic is directed to a virtual IP address associated with the application. The system resolves the DNS for the virtual IP address to determine the physical IP address(es) for one or more application servers (e.g., data center IP addresses for the application servers) that are configured to handle the application traffic (e.g., to provide the service). For example, the system DNS resolves the fqdn associated with the virtual IP address.

The system performs the DNS re-resolution according to a periodic interval (e.g., a predefined frequency) or based on a time to live (TTL) associated with a last response received from the DNS service (e.g., the response to the last DNS re-resolution).

According to various embodiments, in response to obtaining the physical addresses (e.g., the data center IP address(es)) for the one or more application servers that are configured to handle the application traffic, the system stores an indication of the one or more application servers in a dynamic DNAT pool. The DNAT pool may be specifically associated with an application service, such as identifying application servers that handle application traffic for a certain application. Alternatively, the DNAT pool may be associated with a plurality of application services and the DNAT pool can comprise a mapping of application traffic or application services to sets of one or more application servers configured to handle the particular application traffic.

At 410, the system performs a periodic application server probing. The system performs the periodic application server probing to determine the application server status, such as to determine whether the application server is available (e.g., healthy) or unavailable (e.g., unhealthy). In some embodiments, the system periodically probes each application server among a set of application servers in a DNAT pool. The system can independently probe a plurality of application servers based on probing timers individually associated with a particular application server. The independent probing timers enables the system to probe certain application servers more or less frequently. As an example, in response to determining that an application server is unavailable or unhealthy, the system can increase the frequency with which the application server status is probed such as by decreasing the probing timer associated with the application server. In contrast, if the system determines that the application server is available (e.g., healthy), the system can implement a relatively longer probing timer.

At 415, the system dynamically updates a destination network address translation (DNAT) to provide DNS load balancing for application traffic. In some embodiments, the system dynamically updates the DNAT (e.g., the DNAT pool) based at least in part on the DNS re-resolution. For example, the system updates the DNAT pool to reflect a current set of application servers that the DNS service has indicated are assigned/allocated to handle the application traffic. The system may additionally update the DNAT pool based at least in part on the periodic application server probing (e.g., the probing used to assess the application server status). For example, in response to determining that an application server assigned to handle application traffic for a certain application (e.g., application service) is unavailable, the system can update the DNAT pool to indicate that such application server is unavailable and correspondingly load balance application traffic in a manner that ensures that application traffic is not assigned/directed to the unavailable application server(s).

At 420, a determination is made as to whether process 400 is complete. In some embodiments, process 400 is determined to be complete in response to a determination that no further application traffic is to be handled or load balanced, an administrator indicates that process 400 is to be paused or stopped, etc. In response to a determination that process 400 is complete, process 400 ends. In response to a determination that process 400 is not complete, process 400 returns to 405.

FIG. 5 is a flow diagram of a method for directing application traffic to an application server according to various embodiments. In some embodiments, process 500 is implemented at least in part by system 100 of FIG. 1 and/or system 300 of FIG. 3. Process 500 may be implemented by an upstream device such as a worker node, a virtual machine, etc.

A 505, the system obtains application traffic having a destination IP address corresponding to a virtual IP address for an application service that handles application traffic. At 510, the system determines a physical IP address for an application server (e.g., data center IP addresses for the application servers). As an example, the system queries a service that load balances application traffic across a plurality of application servers for the physical address IP associated with the application server to which the application traffic is to be directed. The service that load balances application traffic may query a DNAT pool indicating a set of application servers assigned/allocated to handle the application traffic and select a particular application server from among the set of application servers based at least in part on a load balancing policy (e.g., load balancing may be equally weighted across a set of available application servers or each application server or subset of application servers can have different associated weightings used to load balance the application traffic across the available application servers in the set of application servers). The determining the physical IP address for the application server can correspond to, or include, determining the data center IP addresses for the application server(s). At 515, the system translates the virtual IP address to the physical IP address (e.g., data center IP addresses for the application server(s)). At 520, the system causes the application traffic to be directed to the physical IP address for the application server. At 525, a determination is made as to whether process 500 is complete. In some embodiments, process 500 is determined to be complete in response to a determination that no further application traffic is to be handled, no further application services are to be performed, an administrator indicates that process 500 is to be paused or stopped, etc. In response to a determination that process 500 is complete, process 500 ends. In response to a determination that process 500 is not complete, process 500 returns to 505.

FIG. 6 is a flow diagram of a method for determining an application server that is to handle application traffic according to various embodiments. In some embodiments, process 600 is implemented at least in part by system 100 of FIG. 1 and/or system 300 of FIG. 3. Process 600 may be implemented by an upstream device such as a worker node, a virtual machine, etc.

At 605, the system obtains an indication to determine a physical IP address for an application server (e.g., an data center IP address for the application server) to handle application traffic. At 610, the system queries a destination network translation (DNAT) service for the physical IP address. For example, the system queries or performs a lookup against a dynamic DNAT pool of application servers assigned/configured to handle application traffic for an application service. For example, the system queries a service that provides load balancing of application traffic for an application server to handle the application traffic. The service that provides load balancing can select an available application server from among the dynamic DNAT pool of application servers and return the physical IP address associated with the selected application server (e.g., the data center IP address for the application server). At 615, the system provides an indication of the physical IP address obtained from the DNAT service. For example, the indication comprises the physical IP address for the application server to which the application traffic (e.g., the traffic associated with a particular request/service) is to be directed for handling. In some embodiments, the system provides the indication to another process, service, or system that invoked process 500. For example, the system returns the physical IP address for the application server to process 500 (e.g., 510) so the application traffic can be appropriately directed/mediated. At 620, a determination is made as to whether process 600 is complete. In some embodiments, process 600 is determined to be complete in response to a determination that no further application traffic is to be handled, no further application services are to be performed, no further physical IP addresses are queried or to be returned, no further application traffic is to be load balanced across a set of application servers in the DNAT pool, an administrator indicates that process 600 is to be paused or stopped, etc. In response to a determination that process 600 is complete, process 600 ends. In response to a determination that process 600 is not complete, process 600 returns to 605.

FIG. 7 is a flow diagram of a method for selecting an application server in a dynamic destination network address translation (DNAT) pool to handle application traffic according to various embodiments. In some embodiments, process 700 is implemented at least in part by system 100 of FIG. 1 and/or system 300 of FIG. 3. Process 700 may be implemented by an upstream device such as a worker node, a virtual machine, etc.

In some embodiments, process 700 is invoked by process 600 such as at 610, or by process 500 such as at 510.

At 705, the system obtains a query for a physical IP address for an application server (e.g., a data center IP address(es) for the application server) to handle application traffic. The query for the physical IP address may be sent in connection with mediating application traffic and determining the application server to which to direct the application traffic. The query may be obtained from a load balancing service that is load balancing the application traffic across a set of application servers that a DNS service has indicated are assigned/allocated to handle traffic to a particular domain/virtual IP address associated with an application.

At 710, the system queries a DNAT pool for an indication of one or more application servers mapped to handle application traffic. In some embodiments, the DNAT pool is dynamically updated based at least in part on a DNS re-resolution to resolve the application FQDN or virtual IP address. For example, the system queries the most recent DNAT pool that is updated based on periodic DNS re-resolution. In some embodiments, the DNAT pool is additionally updated based at least in part on an application server status, such as a status that indicates whether the application server is available to handle the application traffic (e.g., a healthy/unhealthy status, etc.).

At 715, the system selects an application server from among the one or more application servers to handle the application server based on a predefined load balancing policy. In some embodiments, the load balancing policy is based at least in part on the DNS re-resolution (e.g., an indication of a set of application servers assigned/allocated to handle the application traffic) and/or status of the application servers (e.g., results of the application server status probing). For example, the system load balances application traffic across available application servers from among the set of application servers that the DNS service has indicated to be assigned/allocated to handle the application traffic. The system performs the application server status probing (e.g., a periodic application server probing to assess the availability/health of the application servers) for the set of application servers, and the system can then load balance across only the healthy/available application servers.

At 720, the system determines the physical IP address for the selected application server. For example, the system determines the data center IP address for the application server.

At 725, the system provides an indication of the physical IP address for the selected application server. For example, the indication comprises the physical IP address for the application server to which the application traffic (e.g., the traffic associated with a particular request/service) is to be directed for handling. In some embodiments, the system provides the indication to another process, service, or system that invoked process 700. For example, the system returns the physical IP address for the application server to process 600 (e.g., at 610) so the application traffic can be appropriately directed/mediated.

At 720, a determination is made as to whether process 700 is complete. In some embodiments, process 600 is determined to be complete in response to a determination that no further application traffic is to be handled, no further application services are to be performed, no further physical IP addresses are queried or to be returned, no further application traffic is to be load balanced across a set of application servers in the DNAT pool, an administrator indicates that process 700 is to be paused or stopped, etc. In response to a determination that process 700 is complete, process 700 ends. In response to a determination that process 700 is not complete, process 700 returns to 705.

FIG. 8 is a flow diagram of a method for selecting an application server in a dynamic destination network address translation (DNAT) pool to handle application traffic according to various embodiments. In some embodiments, process 800 is implemented at least in part by system 100 of FIG. 1 and/or system 300 of FIG. 3. Process 800 may be implemented by an upstream device such as a worker node, a virtual machine, etc.

In some embodiments, process 800 is invoked by process 700, such as at 715.

At 805, the system obtains an indication to determine an application server to handle application traffic from among one or more servers mapped to handle the application traffic.

At 810, the system selects an application server. The system selects the application server from among the application servers mapped to handle the application traffic, for example, the set of application servers that a DNS service has indicated (e.g., in response to DNS re-resolution) are assigned/allocated to handle application traffic (e.g., are mapped to the virtual IP or domain associated with the application traffic). As an example, the application server is selected from among the set of application servers comprised in the then-current dynamic DNAT pool for the application (e.g., the application service or application traffic).

At 815, the system determines whether the application server is available. For example, the system queries the DNAT pool or other mapping of application server to application server statuses to determine the status of the application server (e.g., the status based on a most recent probing of the set of application servers in the then-current DNAT pool). The indication of whether the application server is available may be set in response to the periodic application server probing (e.g., the application server status probing).

In response to determining that the selected application server is available, process 800 proceeds to 820 at which the system stores the selected server in a list of available application servers. For example, the system generates a list of available servers from which to select the application server to handle the application traffic. Thereafter, process 800 proceeds to 825. Conversely, in response to determining that the application server is not available, process 800 proceeds to 825.

At 825, the system determines whether any other application servers are to be assessed for availability to handle application traffic. For example, the system determines whether the DNAT pool comprises any further application servers to be evaluated. In response to determining that no further application servers are to be assessed for availability, process 800 proceeds to 830.

At 830, the system selects an application server from among the one or more application servers identified on the list of available application servers based at least in part on a predefined load balancing policy. [load balancing policy-updated . . . determined based on a DNS re-resolution]

At 835, the system provides an indication of the selected application server. For example, the indication comprises the physical IP address for the application server (e.g., data center IP address(es) for the application server) to which the application traffic (e.g., the traffic associated with a particular request/service) is to be directed for handling. In some embodiments, the system provides the indication to another process, service, or system that invoked process 800. For example, the system returns the physical IP address for the application server to process 600 (e.g., at 610) or process 700 (e.g., at 715) so the application traffic can be appropriately directed/mediated.

At 840, a determination is made as to whether process 800 is complete. In some embodiments, process 800 is determined to be complete in response to a determination that no further application traffic is to be handled, no further application services are to be performed, no further physical IP addresses are queried or to be returned, no further application traffic is to be load balanced across a set of application servers in the DNAT pool, an administrator indicates that process 800 is to be paused or stopped, etc. In response to a determination that process 800 is complete, process 800 ends. In response to a determination that process 800 is not complete, process 800 returns to 805.

FIG. 9 is a flow diagram of a method for updating a dynamic destination network address translation (DNAT) pool according to various embodiments. In some embodiments, process 900 is implemented at least in part by system 100 of FIG. 1 and/or system 300 of FIG. 3. Process 900 may be implemented by an upstream device such as a worker node, a virtual machine, etc.

In some embodiments, process 900 is invoked by process 400, such as at 405. Additionally, or alternatively, process 900 may be invoked by process 500 (e.g., at 510). Process 900 may also be invoked by a service that periodically updates a DNAT pool with a set of application servers that are assigned/allocated to handle application traffic based on a DNS service resolving of the virtual IP or domain for the application traffic. Additionally, or alternatively, the service that updates the DNAT pool can invoke process 900 in response to determining that a TTL for a last DNS resolving has expired (or within a predefined time period before the TTL is set to expire).

At 905, the system obtains an indication to resolve the DNS for a virtual IP address associated with application traffic. At 910, the system queries a DNS service for an indication of one or more physical IP addresses based at least in part on the virtual IP address. At 915, the system obtains an indication of the one or more physical IP addresses for a set of application servers (e.g., data center IP addresses for the application servers) allocated to handle application traffic for the virtual IP address. At 920, the system updates a dynamic DNAT pool based at least in part on the response from the DNS service. The system can update the DNAT pool to include the current set of application servers assigned/allocated to handle the application traffic based on the response from the querying of the DNS service (e.g., the response from the most recent DNS re-resolution). Additionally, the system may remove any application servers that were in the DNAT pool but are no longer within the set of application servers assigned/allocated to handle the application traffic based on the most recent DNS re-resolution. At 925, a determination is made as to whether process 900 is complete. In some embodiments, process 900 is determined to be complete in response to a determination that no further application traffic is to be handled, no further application services are to be performed, an administrator indicates that process 900 is to be paused or stopped, etc. In response to a determination that process 900 is complete, process 900 ends. In response to a determination that process 900 is not complete, process 900 returns to 905.

FIG. 10 is a flow diagram of a method for updating a load balancing policy for handling application traffic across a plurality of application servers according to various embodiments. In some embodiments, process 1000 is implemented at least in part by system 100 of FIG. 1 and/or system 300 of FIG. 3. Process 1000 may be implemented by an upstream device such as a worker node, a virtual machine, etc.

In some embodiments, process 1000 is invoked in response to a DNS re-resolution or an application server probing. For example, if the response to the DNS re-resolution indicates that a set of application servers has changed assigned to handle application traffic has changed or if the response to the DNS re-resolution indicates a load balancing to be implemented or a weighting for the application servers within the set of application servers, the system can invoke process 1000 to correspondingly update the load balancing policy. Additionally, or alternatively, the system can update the load balancing policy in response to determining that the status of an application server within the current-version of the dynamic DNAT pool has changed (e.g., from unavailable to available, or from available to unavailable, etc.). For example, the system can update the load balancing policy to ensure that application traffic is load balanced across only those application servers that are healthy/available from among the set of application servers within the DNAT pool associated with the application traffic.

At 1005, the system obtains an indication to update a load balancing policy. In some embodiments, the system determines to perform an update to the load balancing policy in response to receiving a response based on the DNS re-resolution. Additionally, or alternatively, the system determines to perform the update to the load balancing policy in response to a response to an application server probing (e.g., a probing to assess the application server availability or health service).

At 1010, the system determines a manner according to which traffic is to be balanced across a set of application servers in the dynamic DNAT pool based at least in part on a querying of a DNS service for resolving a virtual IP address. The system determines the load balancing based on the DNS re-resolution.

According to various embodiments, if the system receives an SRV record in connection with the DNS re-resolution, the system obtains a load balancing from the SRV record. The SRV record identifies one or more application servers assigned/allocated to handle application traffic. In addition, the SRV may comprise an indication of a weighting for the one or more application servers. The server updates the load balancing policy to reflect a load balancing in accordance with the weightings comprised in the SRV record.

According to various embodiments, the system can determine to equally weight the set of application servers in the dynamic DNAT pool subject to a reallocation of the weighting for an application server(s) that are determined to be unavailable or unhealthy. The system can dynamically update the load balancing policy as the availability or health status of application servers change.

At 1015, the system updates the load balancing policy based at least in part on the manner according to which application traffic is to be balanced across a set of application servers.

At 1020, a determination is made as to whether process 1000 is complete. In some embodiments, process 1000 is determined to be complete in response to a determination that no further application traffic is to be handled, no further application servers are to be balanced for one or more application services, an administrator indicates that process 1000 is to be paused or stopped, etc. In response to a determination that process 1000 is complete, process 1000 ends. In response to a determination that process 1000 is not complete, process 1000 returns to 1005.

FIG. 11 is a flow diagram of a method for probing a status of an application server according to various embodiments. In some embodiments, process 1100 is implemented at least in part by system 100 of FIG. 1 and/or system 300 of FIG. 3. Process 1100 may be implemented by an upstream device such as a worker node, a virtual machine, etc.

At 1105, the system obtains an indication to probe an application server in a dynamic DNAT pool. The system probes the application server to determine an availability (e.g., a health status) of the application server. The system may obtain the indication to probe the application server in response to the lapsing of a probing timer associated with the application server, or in response to a change in a set of application servers in the dynamic DNAT pool for the application (e.g., in response to the dynamic DNAT pool being updated based on a DNS re-resolution).

At 1110, the system obtains a probing timer for the application server. The system may start the probing timer, for example, on the first iteration since the application server was last probed or the first iteration since the DNAT pool was updated based on a DNS re-resolution.

At 1115, the system determines whether to probe the application server. In some embodiments, the system determines to probe the application server in response to determining that the probing timer has elapsed. For example, the system can periodically probe the application server according to a predetermined time interval or frequency. In response to determining that the application server is not to be proved (e.g., the probing timer has not yet elapsed), process 1100 returns to 1110 and the process iterates over 1110-1115 until the probing timer has elapsed. Conversely, in response to determining that the application server is to be probed, process 1100 proceeds to 1120.

At 1120, the system sends a probing communication to the application server. For example, the system sends a status check or a dummy query, etc. to the application server.

At 1125, the system determines whether it has received a response from the application server. For example, the system determines whether the application server has responded to the probing communication (e.g., the status check, dummy query, etc.) or otherwise provided an indication of the application server status (e.g., available/healthy, or unavailable/unhealthy, etc.).

In response to determining that the system has received a response from the application server at 1125, process 1100 proceeds to 1130 at which the system determines whether the application server is healthy or otherwise available to process application traffic. For example, the system determines whether the response from the application server indicates that the application server is available. In response to determining that the application server is healthy, process 1100 proceeds to 1140 at which the system deems the application server as available. Conversely, in response to determining that the application server is not healthy (e.g., based on the response from the application server), process 1100 proceeds to 1145 at which the system deems the application server as unavailable.

In response to determining that the system has not received a response from the application server at 1125, process 1100 proceeds to 1135 at which the system determines whether a predefined time period since the probing communication was sent has elapsed. The predefined timer period may be configurable and/or set to correspond to a time at which the probing communication is timed out (e.g., a time period after which the application server should be deemed non-responsive or unavailable). In response to determining that the predefined time period has not elapsed, process 1100 returns to 1125 and process 1100 iterates over 1125-1135 until the predefined time period has elapsed. In response to determining that the predefined timer period has elapsed, process 1100 proceeds to 1145 at which the system deems the application server as unavailable.

At 1150, the system updates the status of the application server. For example, the system sets the status of the application server as available (e.g., healthy) or unavailable (e.g., unhealthy). The state of the application server(s) can be stored in the DNAT pool (e.g., as metadata for the DNAT pool, such as metadata for each application server record in the DNAT pool). In other implementations, the state of the application server is stored in another data structure that can be queried when the system determines how to load balance application traffic.

The system uses the application server state to determine whether to route traffic to the application server. For example, if the application server state indicates the application server is unavailable, the system will not route application traffic to the application server while it is unavailable or will include the application server in the load balancing of application servers across the DNAT pool. Conversely, if the application server state indicates the application server is available, the system may route application traffic to the application server while it is available. For example, the system can include the available application server in the pool of application servers across which the system will load balance the application traffic (e.g., according to a load balancing policy).

At 1155, a determination is made as to whether process 1100 is complete. In some embodiments, process 1100 is determined to be complete in response to a determination that no further application traffic is to be handled, no further application services are to be performed, no further physical IP addresses are queried or to be returned, no further application traffic is to be load balanced across a set of application servers in the DNAT pool, no further application servers are to be probed for an availability/healthy status, an administrator indicates that process 1100 is to be paused or stopped, etc. In response to a determination that process 1100 is complete, process 1100 ends. In response to a determination that process 1100 is not complete, process 1100 returns to 1105.

FIG. 12 is a flow diagram of a method for updating a probing timer for an application server according to various embodiments. In some embodiments, process 1200 is implemented at least in part by system 100 of FIG. 1 and/or system 300 of FIG. 3. Process 1200 may be implemented by an upstream device such as a worker node, a virtual machine, etc.

In some embodiments, process 1200 is invoked by a system or service that is configured to manage a dynamic DNAT pool of application servers across which application traffic is to be load balanced and/or to load balance application traffic across a set of application servers. For example, process 1200 is invoked to perform an update of the probing timer for probing a status of an application server based on whether the application server is available or otherwise based on a health of the application server.

In some embodiments, process 1200 is invoked by process 1100, such as at 1145.

At 1205, the system obtains an indication that the application server is determined to be unavailable. The system may determine that the application server is unavailable based on a probing of the application server.

At 1210, the system updates the probing timer for the application server. The system updates the probing timer to be shorter so the application server is probed more frequently. As an illustrative example, if the probing timer for a healthy/available application server is 3 minutes, the system may update the probing timer to be 1 minute in response to detecting that the application server is unavailable. The probing timers may be configurable and various other lengths for the probing timers may be implemented. In response to detecting that the application server is available (e.g., has switched from being unhealthy/unavailable to healthy/available), the system can update the probing timer to increase the probing timer so the application server is probed relatively less frequently. The system can store a mapping of probing timers to application server statuses, such as storing a first probing timer for available application servers and a second probing timer for unavailable application servers.

In some embodiments, each the system has individual/independent probing timers for the set of application servers in the DNAT pool, and the system configures/updates the probing timers independently based on the respective results from the probing of the set of application servers.

At 1215, the system provides an indication of the probing timer for the application server. For example, the indication comprises the probing timer set for unavailable application servers. In some embodiments, the system provides the indication to another process, service, or system that invoked process 1200. For example, the system 1215 returns the updated probing timer to process 1100 (e.g., 1145) for the next iteration of probing the application server to determine the application server status.

At 1220, a determination is made as to whether process 1200 is complete. In some embodiments, process 1200 is determined to be complete in response to a determination that no further probing timers are to be updated, no further application servers are deemed unavailable, an administrator indicates that process 1200 is to be paused or stopped, etc. In response to a determination that process 1200 is complete, process 1200 ends. In response to a determination that process 1200 is not complete, process 1200 returns to 1205.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
perform a DNS re-resolution for resolving an application Fully Qualified Domain Name (FQDN) to obtain a plurality of IP addresses for a plurality of application servers;
perform periodic application server probing; and
dynamically update a destination network address translation (DNAT) to provide DNS load balancing for application traffic, wherein the DNAT is updated based at least in part on one or more of the DNS re-resolution and the application server probing; and
a memory coupled to the one or more processors and configured to provide the one or more processors with instructions.

2. The system of claim 1, wherein the DNAT is updated to indicate a set of application servers that are healthy among the plurality of application servers identified by a DNS server in response to the DNS re-resolution.

3. The system of claim 2, wherein an application server is deemed healthy in response to determining that the application server handles application traffic based at least in part on the periodic application server probing.

4. The system of claim 2, wherein the DNAT is dynamically and automatically updated based on results from a most recent DNS re-resolution and a most recent application server probing.

5. The system of claim 1, wherein the DNS re-resolution is performed periodically according to a predefined frequency.

6. The system of claim 1, wherein the DNS re-resolution is performed based on a time to live (TTL) indication.

7. The system of claim 1, wherein the application traffic is mapped to a virtual IP address that is used by a client device to access an application provided by the plurality of application servers.

8. The system of claim 1, wherein the plurality of application servers are accessible by a client device via a security service gateway that is configured to authenticate the client device and mediate the application traffic.

9. The system of claim 1, wherein the DNS proving is performed by a Zero Trust Network (ZTN) connector service that connects application traffic to a set of application servers in a DNAT pool.

10. The system of claim 1, wherein the periodic application server probing is performed by a Zero Trust Network (ZTN) connector service that connects application traffic to a set of application servers in a DNAT pool.

11. The system of claim 10, wherein a predefined time interval for the periodic application server probing is between one minute and five minutes.

12. The system of claim 11, wherein the ZTN connector service more frequently performs the application server probing with respect to a particular application server in response to a determination that the particular application server is not healthy.

13. The system of claim 1, wherein a set of DNAT rules are programmed in a connector path in a manner that each new session is automatically load balanced across healthy application servers from among the plurality of applications servers identified from a most recent DNS re-resolution.

14. The system of claim 1, wherein a DNS server provides a response to a query for the DNS re-resolution, and the response indicates the plurality of IP address for the plurality of applications across which application traffic is to be load balanced.

15. The system of claim 14, wherein in response to determining that the response does not indicate a particular load balancing to be implemented for application traffic to the plurality of application servers, a set of rules for the DNAT is configured to load balance equally across the plurality of application servers.

16. The system of claim 14, wherein in response to determining that the response from the DNS server comprises an indication of application server weightings for distributing application traffic across the plurality of application servers, configuring a set of DNAT rules to load balance application traffic across the plurality of application servers in accordance with the application server weightings.

17. The system of claim 1, wherein in response to a determination that an application server identified in a current DNAT pool is not available to handle at least a subset of the application traffic, the at least the subset of the application traffic is redistributed to other healthy application servers of the plurality of application servers.

18. The system of claim 1, wherein performing periodic application server probing comprises, for each of the plurality of application servers to a DNS server indicates application traffic is to be distributed across, individually configuring an application server probing timer for the particular application server.

19. A method, comprising:
performing a DNS re-resolution for resolving an application Fully Qualified Domain Name (FQDN) to obtain a plurality of IP addresses for a plurality of application servers;
performing periodic application server probing; and
dynamically updating a destination network address translation (DNAT) to provide DNS load balancing for application traffic, wherein the DNAT is updated based at least in part on one or more of the DNS re-resolution and the application server probing.

20. A computer program product embodied in a non-transitory computer readable medium and comprising computer instructions for:
performing a DNS re-resolution for resolving an application Fully Qualified Domain Name (FQDN) to obtain a plurality of IP addresses for a plurality of application servers;
performing periodic application server probing; and
dynamically updating a destination network address translation (DNAT) to provide DNS load balancing for application traffic, wherein the DNAT is updated based at least in part on one or more of the DNS re-resolution and the application server probing.
